(19) United States
(12) Patent Application Publication
(10) Pub. No.: US 2018/0006894 A1
(43) Pub. Date: Jan. 4, 2018

(54) PORTABLE DEVICE FOR CABLING ASSISTANCE

(71) Applicant: Microsoft Technology Licensing, LLC, Redmond, WA (US)

(72) Inventors: Adrian Power, Seattle, WA (US); Faraz Yusuf, Seattle, WA (US); Mikhail Cherniak, Kichiner (CA); Peter Hill, Seattle, WA (US)

(21) Appl. No.: 15/197,392

(22) Filed: Jun. 29, 2016

(51) Int. Cl. H04L 12/24; H04L 5/00; H04B 10/25

(52) U.S. Cl. CPC H04L 41/12; H04B 10/25; H04L 5/0048

(57) ABSTRACT

A portable handheld computing device includes a network interface and a control unit. The network interface is configured to interface the portable handheld computing device to a network cable. The control unit is configured to establish a link over the network cable. The control unit is also configured to receive, at a first endpoint of the network cable, at least identifying information via a neighbor discovery protocol. The identifying information includes identification of a device to which a second endpoint of the network cable is connected. The control unit is also configured to decode the identifying information.

### BACKGROUND

Today's networks are made up of devices that, in some cases, may support numerous links to a single device. One of the challenges is ensuring that links connect to the correct device on the correct port. The people doing these connections often have limited access to the devices.

### BRIEF DESCRIPTION OF THE DRAWINGS

Non-limiting and non-exhaustive examples of the present disclosure are described with reference to the following drawings. In the drawings, like reference numerals refer to like parts throughout the various figures unless otherwise specified. These drawings are not necessarily drawn to scale.

For a better understanding of the present disclosure, reference will be made to the following Detailed Description, which is to be read in association with the accompanying drawings, in which:

FIG. 1 is a block diagram illustrating one example of a suitable environment in which aspects of the technology may be employed;

FIG. 2 is a block diagram illustrating one example of a suitable computing device according to aspects of the disclosed technology;

FIG. 3 is a block diagram illustrating an example of a device for cabling assistance;

FIG. 4 is a logical flow diagram illustrating an example of a process for cabling assistance; and

FIG. 5 is a block diagram illustrating an example of a system for cabling assistance that may include an example of the device of FIG. 3, arranged in accordance with aspects of the present disclosure.

### DETAILED DESCRIPTION

The following description provides specific details for a thorough understanding of, and enabling description for, various examples of the technology. One skilled in the art will understand that the technology may be practiced without many of these details. In some instances, well-known structures and functions have not been shown or described in detail to avoid unnecessarily obscuring the description of examples of the technology. It is intended that the terminology used in this disclosure be interpreted in its broadest reasonable manner, even though it is being used in conjunction with a detailed description of certain examples of the technology. Although certain terms may be emphasized below, any terminology intended to be interpreted in any restricted manner will be overtly and specifically defined as such in this Detailed Description section. Throughout the specification and claims, the following terms take at least the meanings explicitly associated herein, unless the context dictates otherwise. The meanings identified below do not necessarily limit the terms, but merely provide illustrative examples for the terms. For example, each of the terms “based on” and “based upon” is not exclusive, and is equivalent to the term “based, at least in part, on”, and includes the option of being based on additional factors, some of which may not be described herein. As another example, the term “via” is not exclusive, and is equivalent to the term “via, at least in part”, and includes the option of being via additional factors, some of which may not be described herein. The meaning of “in” includes “in” and “on.” The phrase “in one embodiment,” or “in one example,” as used herein does not necessarily refer to the same embodiment or example, although it may. Use of a particular textual numeric designators does not imply the existence of lesser-valued numerical designators. For example, reciting “a widget selected from the group consisting of a third foo and a fourth bar” would not itself imply that there are at least three foo, nor that there are at least four bar, elements. References in the singular are made merely for clarity of reading and include plural references unless plural references are specifically excluded. The term “or” is an inclusive “or” operator unless specifically indicated otherwise. For example, the phrases “A or B” means “A, B, or A and B.” As used herein, the terms “component” and “system” are intended to encompass hardware, software, or various combinations of hardware and software. Thus, for example, a system or component may be a process, a process executing on a computing device, the computing device, or a portion thereof.

### INTRODUCTION

Briefly stated, a portable handheld computing device includes a network interface and a control unit. The network interface is configured to interface the portable handheld computing device to a network cable. The control unit is configured to establish a link over the network cable. The control unit is also configured to receive, at a first endpoint of the network cable, at least identifying information via a neighbor discovery protocol. The identifying information includes identification of a device to which a second endpoint of the network cable is connected. The control unit is also configured to decode the identifying information.

### Illustrative Devices/Operating Environments

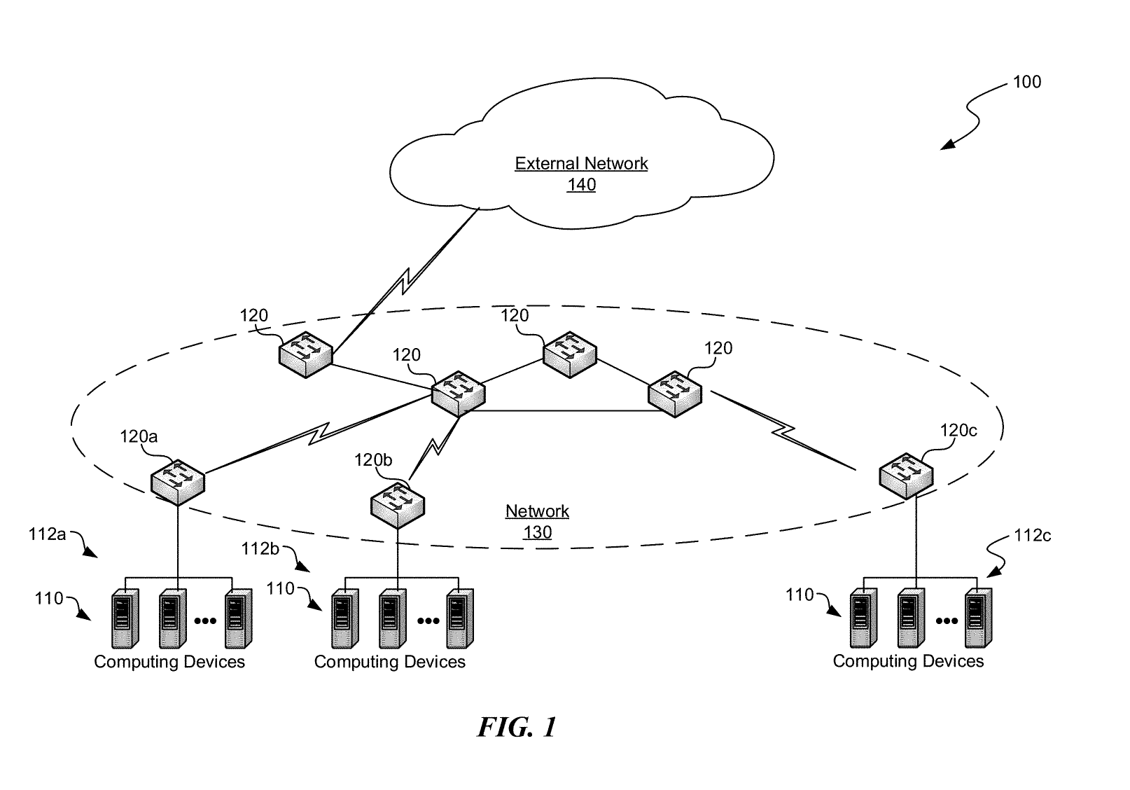

FIG. 1 is a diagram of environment 100 in which aspects of the technology may be practiced. As shown, environment 100 includes computing devices 110, as well as network nodes 120, connected via network 130. Even though particular components of environment 100 are shown in FIG. 1, in other examples, environment 100 can also include additional and/or different components. For example, in certain examples, the environment 100 can also include network storage devices, maintenance managers, and/or other suitable components (not shown).

As shown in FIG. 1, network 130 can include one or more network nodes 120 that interconnect multiple computing devices no, and connect computing devices no to external network 140, e.g., the Internet or an intranet. For example, network nodes 120 may include switches, routers, hubs, network controllers, or other network elements. In certain examples, computing devices no can be organized into racks, action zones, groups, sets, or other suitable divisions. For example, in the illustrated example, computing devices no are grouped into three host sets identified individually as first, second, and third host sets 112a-112c. In the illustrated example, each of host sets 112a-112c is operatively coupled to a corresponding network node 120a-120c, respectively, which are commonly referred to as “top-of-rack” or “TOR” network nodes. TOR network nodes 120a-120C can then be operatively coupled to additional network nodes 120 to form a computer network in a hierarchical, flat, mesh, or other suitable types of topology that allows communication between computing devices 110 and external network 140. In other examples, multiple host sets 112a-112c may share a single network node 120. Computing devices 110 may be virtually any type of general- or specific-purpose computing device. For example, these computing devices may be user devices such as desktop computers, laptop computers, tablet computers, display devices, cameras, printers, or smartphones. However, in a data center environment, these computing devices may be server devices such as application server computers, virtual computing host computers, or file server computers. Moreover, computing devices 110 may be individually configured to provide computing, storage, and/or other suitable computing services.

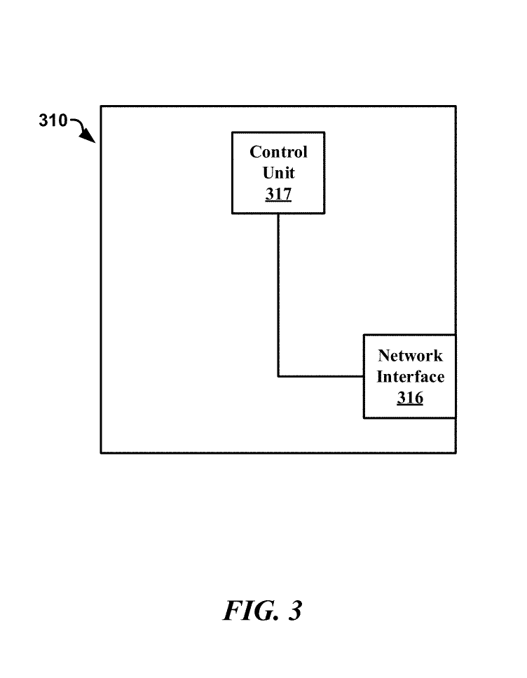

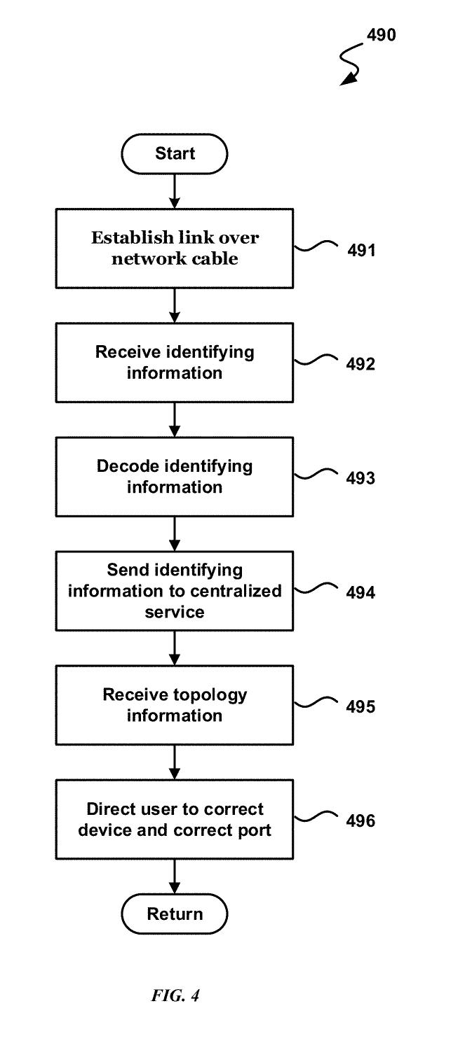

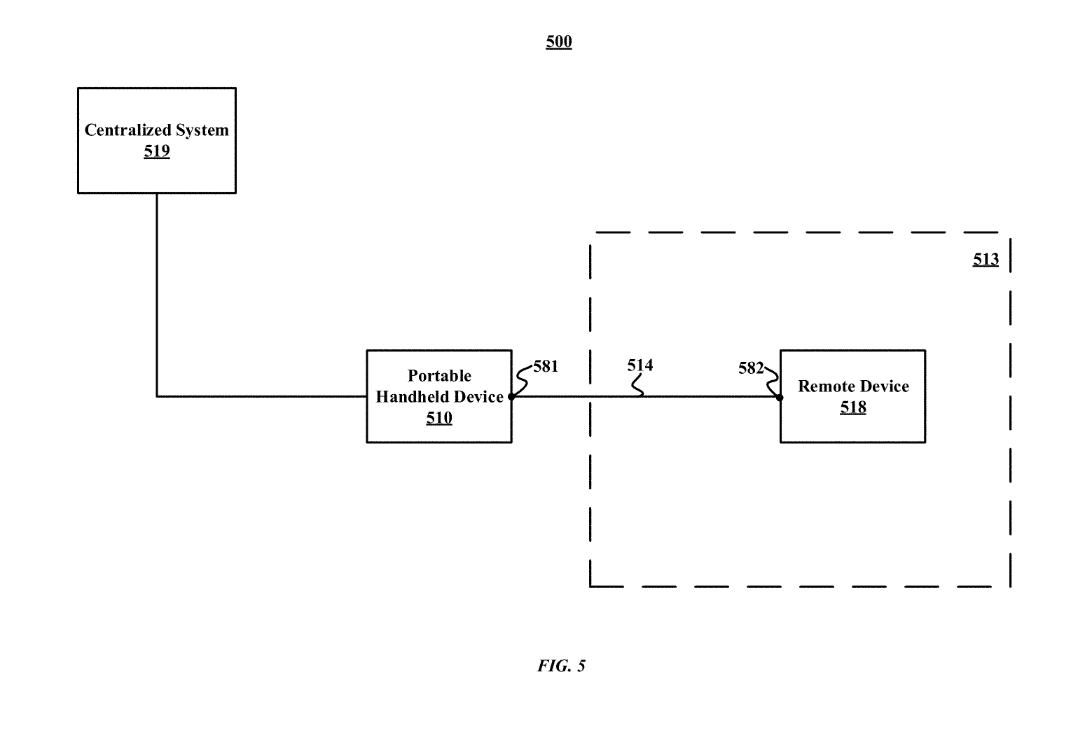

In some examples, one of the computing device 110 is a portable handheld computing device coupled wirelessly to network 130, in which the portable handheld computing device may be an example of the portable handheld computing devices illustrated in FIG. 3 or FIG. 5 below. In some example, the portable handheld computing device may perform a process, such the process illustrated in FIG. 4 below. In some examples, some of the computing devices no are network devices that are part of a data center such as the data center of FIG. 5 as discussed in greater detail below, where in some examples the data center is in the process of being installed, and in other examples the data center has already been installed. In some examples, one of computing devices no is a centralized service, such as an example of the centralized service shown in FIG. 5 and discussed in greater detail below.

### Illustrative Computing Device

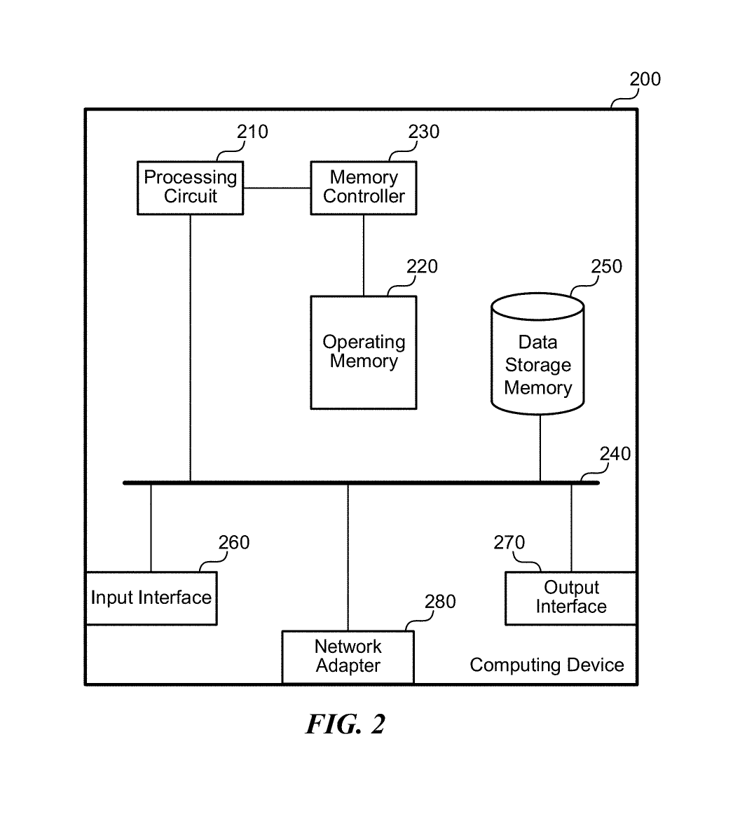

FIG. 2 is a diagram illustrating one example of computing device 200 in which aspects of the technology may be practiced. Computing device 200 may be virtually any type of general- or specific-purpose computing device. For example, computing device 200 may be a user device such as a desktop computer, a laptop computer, a tablet computer, a display device, a camera, a printer, or a smartphone. Likewise, computing device 200 may also be server device such as an application server computer, a virtual computing host computer, or a file server computer, e.g., computing device 200 may be an example of computing device 110 or network node 120 of FIG. 1. Likewise, computer device 200 may be an example of portable handheld computing device, as discussed in greater detail below. As illustrated in FIG. 2, computing device 200 includes processing circuit 210, operating memory 220, memory controller 230, data storage memory 250, input interface 260, output interface 270, and network adapter 280. Each of these afore-listed components of computing device 200 includes at least one hardware element.

Computing device 200 includes at least one processing circuit 210 configured to execute instructions, such as instructions for implementing the herein-described workloads, processes, or technology. Processing circuit 210 may include a microprocessor, a microcontroller, a graphics processor, a coprocessor, a field programmable gate array, a programmable logic device, a signal processor, or any other circuit suitable for processing data. The aforementioned instructions, along with other data (e.g., datasets, metadata, operating system instructions, etc.), may be stored in operating memory 220 during run-time of computing device 200. Operating memory 220 may also include any of a variety of data storage devices/components, such as volatile memories, semi-volatile memories, random access memories, static memories, caches, buffers, or other media used to store run-time information. In one example, operating memory 220 does not retain information when computing device 200 is powered off. Rather, computing device 200 may be configured to transfer instructions from a non-volatile data storage component (e.g., data storage component 250) to operating memory 220 as part of a booting or other loading process.

Operating memory 220 may include 4^{th} generation double data rate (DDR4) memory, 3^{rd} generation double data rate (DDR3) memory, other dynamic random access memory (DRAM), High Bandwidth Memory (HBM), Hybrid Memory Cube memory, 3D-stacked memory, static random access memory (SRAM), or other memory, and such memory may comprise one or more memory circuits integrated onto a DIMM, SIMM, SODIMM, or other packaging. Such operating memory modules or devices may be organized according to channels, ranks, and banks. For example, operating memory devices may be coupled to processing circuit 210 via memory controller 230 in channels. One example of computing device 200 may include one or two DIMMs per channel, with one or two ranks per channel. Operating memory within a rank may operate with a shared clock, and shared address and command bus. Also, an operating memory device may be organized into several banks where a bank can be thought of as an array addressed by row and column. Based on such an organization of operating memory, physical addresses within the operating memory may be referred to by a tuple of channel, rank, bank, row, and column.

Despite the above-discussion, operating memory 220 specifically does not include or encompass communications media, any communications medium, or any signals per se.

Memory controller 230 is configured to interface processing circuit 210 to operating memory 220. For example, memory controller 230 may be configured to interface commands, addresses, and data between operating memory 220 and processing circuit 210. Memory controller 230 may also be configured to abstract or otherwise manage certain aspects of memory management from or for processing circuit 210. Although memory controller 230 is illustrated as single memory controller separate from processing circuit 210, in other examples, multiple memory controllers may be employed, memory controller(s) may be integrated with operating memory 220, or the like. Further, memory controller(s) may be integrated into processing circuit 210. These and other variations are possible.

In computing device 200, data storage memory 250, input interface 260, output interface 270, and network adapter 280 are interfaced to processing circuit 210 by bus 240. Although, FIG. 2 illustrates bus 240 as a single passive bus, other configurations, such as a collection of buses, a collection of point to point links, an input/output controller, a bridge, other interface circuitry, or any collection thereof may also be suitably employed for interfacing data storage memory 250, input interface 260, output interface 270, or network adapter 280 to processing circuit 210.

In computing device 200, data storage memory 250 is employed for long-term non-volatile data storage. Data storage memory 250 may include any of a variety of non-volatile data storage devices/components, such as non-volatile memories, disks, disk drives, hard drives, solid-state drives, or any other media that can be used for the non-volatile storage of information. However, data storage memory 250 specifically does not include or encompass communications media, any communications medium, or any signals per se. In contrast to operating memory 220, data storage memory 250 is employed by computing device 200 for non-volatile long-term data storage, instead of for run-time data storage.

Also, computing device 200 may include or be coupled to any type of processor-readable media such as processor-readable storage media (e.g., operating memory 220 and data storage memory 250) and communication media (e.g., communication signals and radio waves). While the term processor-readable storage media includes operating memory 220 and data storage memory 250, the term “processor-readable storage media,” throughout the specification and the claims whether used in the singular or the plural, is defined herein so that the term “processor-readable storage media” specifically excludes and does not encompass communications media, any communications medium, or any signals per se. However, the term “processor-readable storage media” does encompass processor cache, Random Access Memory (RAM), register memory, and/or the like.

Computing device 200 also includes input interface 260, which may be configured to enable computing device 200 to receive input from users or from other devices. In addition, computing device 200 includes output interface 270, which may be configured to provide output from computing device 200. In one example, output interface 270 includes a frame buffer, graphics processor, graphics processor or accelerator, and is configured to render displays for presentation on a separate visual display device (such as a monitor, projector, virtual computing client computer, etc.). In another example, output interface 270 includes a visual display device and is configured to render and present displays for viewing.

In the illustrated example, computing device 200 is configured to communicate with other computing devices or entities via network adapter 280. Network adapter 280 may include a wired network adapter, e.g., an Ethernet adapter, a Token Ring adapter, or a Digital Subscriber Line (DSL) adapter. Network adapter 280 may also include a wireless network adapter, for example, a Wi-Fi adapter, a Bluetooth adapter, a ZigBee adapter, a Long Term Evolution (LTE) adapter, or a 5G adapter.

Although computing device 200 is illustrated with certain components configured in a particular arrangement, these components and arrangement are merely one example of a computing device in which the technology may be employed. In other examples, data storage memory 250, input interface 260, output interface 270, or network adapter 280 may be directly coupled to processing circuit 210, or be coupled to processing circuit 210 via an input/output controller, a bridge, or other interface circuitry. Other variations of the technology are possible.

Some examples of computing device 200 include at least one storage memory (e.g. data storage memory 250), at least one operating memory (e.g., operating memory 220) and at least one processor (e.g., processing unit 210) that are respectively adapted to store and execute processor-executable code that, in response to execution, enables computing device 200 to perform actions. In some examples, computing device 200 is a portable handheld computing device, such as an example of the portable handheld computing device of FIG. 3 or FIG. 5 and discussed in greater detail below. In some examples, computing device 200 is a portable handheld computing device that is configured to process a process, such as, for example, the process illustrated in FIG. 4 and discussed below in conjunction with FIG. 4. In some examples, computing device 200 is an example of a remote device in a data center, as shown in FIG. 5 and discussed in greater detail below. In some examples, computing device 200 is an example of a centralized service, such as the centralized service shown in FIG. 5 and discussed in greater detail below.

### Illustrative Device

FIG. 3 is a block diagram illustrating an example of a device (310) for cabling assistance. In some examples, device 310 is a portable handheld computing device. In other embodiments, device 310 is either not portable, not handheld, or neither portable nor handheld. Device 310 includes network interface 316 and control unit 317. Network interface 316 is configured to interface portable handheld computing device 310 to a network cable. Control unit 317 is configured to establish a link over the network cable; to receive, at a first endpoint of the network cable, at least identifying information via a neighbor discovery protocol; and to decode the identifying information. The identifying information includes identification of a first network device to which a second endpoint of the network cable is connected. By decoding the identifying information, portable handheld computing device 310 determines which device the second endpoint of the network cable is connected to.

In some examples, the network cable is a fiber optic cable. In other various examples, the network cable may be a coaxial cable, twisted pair cable, power cable, or any other any suitable cable.

A neighbor discovery protocol may include any suitable protocol that can be used by devices connected by a cable to identify each other via the protocol. In some examples, the neighbor discovery protocol is Link Layer Discovery Protocol (LLDP), Link Layer Topology Discovery (LLTD), Cisco Discovery Protocol (CDP), Foundry Discovery Protocol (FDP), Nortel Discovery Protocol (NDP), Simple Network Management Protocol (SNMP), SynOptics Network Management Protocol (SONMP), or the like. In other examples, other suitable neighbor discovery protocols may be used.

In some examples, control unit 317 includes at least one storage memory, at least one operating memory, and at least one processor that are respectively adapted to store and execute processor-executable code that, upon execution, enables control unit 317 to perform actions, such as, for example, the process illustrated in FIG. 4 and discussed below in conjunction with FIG. 4. While some example of control unit 317 operate based on software executed by at least one processor, various examples of control unit 317 may use software, firmware, hardware, or any suitable combination thereof, including a system-on-a-chip, application-specific integrated circuit, and/or other suitable hardware and/or firmware.

A further discussion of some examples of establishing the link and receiving the identifying information is discussed in greater detail below in conjunction with FIG. 4.

### Illustrative Processes

For clarity, the processes described herein are described in terms of operations performed in particular sequences by particular devices or components of a system. However, it is noted that other processes are not limited to the stated sequences, devices, or components. For example, certain acts may be performed in different sequences, in parallel, omitted, or may be supplemented by additional acts or features, whether or not such sequences, parallelisms, acts, or features are described herein. Likewise, any of the technology described in this disclosure may be incorporated into the described processes or other processes, whether or not that technology is specifically described in conjunction with a process. The disclosed processes may also be performed on or by other devices, components, or systems, whether or not such devices, components, or systems are described herein. These processes may also be embodied in a variety of ways. For example, they may be embodied on an article of manufacture, e.g., as computer-readable instructions stored in a computer-readable storage medium or be performed as a computer-implemented process. As an alternate example, these processes may be encoded as computer-executable instructions and transmitted via a communications medium.

FIG. 4 is a logical flow diagram illustrating process 490 for cabling assistance. After a start block, the process proceeds to block 491. At block 491, a link is established over the network cable between a portable handheld computing device that is connected to a first endpoint of the network cable and a first network device that is connected to the second endpoint of the network cable. The description of the portable handheld computing device is by way of example; in other examples, the portable handheld computing device may be replaced by a device that is either not portable, not handheld, or neither portable nor handheld. The process then moves to block 492. At block 492, at the first endpoint of the network cable, at least identifying information is received via a neighbor discovery protocol. The identifying information includes identification of a device to which a second endpoint of the network cable is connected. The process then advances to block 493.

At block 493, the identifying information is decoded. The process then proceeds to block 494. At block 494, the identifying information is send to a centralized service. The centralized service includes one or more computing devices. The process then moves to block 495, where topology information is received from the centralized service. In some examples, the topology information may include identification of the device and/or port to which the first endpoint of the network cable should be connected based on an intended topology stored in the centralized service. The process then advances to block 496, where the user is directed to the correct device and/or port to which the first endpoint of the network cable should be connected based on an intended topology stored in the centralized service.

Directing the user to the correct device and/or port to which the first endpoint of the network cable should be connected is accomplished in different ways in different examples. In some examples, the device displays, to the user, the correct device and/or port to which the first endpoint of the network cable should be connected on a screen of the portable handheld device. In other examples, LED beacons are used to direct the user to the correct device and/or port to which first endpoint of the network cable should be connected, as explained in greater detail below with regard to FIG. 5. The process then proceeds to a return block, where other processing is resumed.

In some examples, establishing a link over the network cable includes establishing a layer two link. “Layer two” here refers to layer two of the Open Systems Interconnection (OSI) model of network communication, where layer two of the OSI model is the data link layer. Establishing such a link may include, for example, sending a message out over the network cable in accordance with a layer two protocol, for example via a frame, where the message announces that the device sending the message is a layer two device (i.e., a node) and indicates the protocol that is being used for communication. The node at the other end of the layer two link may respond with an acknowledgement and/or a similar message.

Once a layer two link is established between two directly connected layer two devices (i.e., nodes), if both directly connected nodes use the LDDP protocol, then according to the LDDP protocol, each node sends out periodically, for example via a frame, to the other nodes to which it is directly connected, certain LLDP information. The LLDP information may include, for example, Chassis ID and port ID. In some examples, the portable handheld device establishes a layer two link over the network cable via LDDP, then receives the periodically sent LDDP information from the remote device after the level two link has been established, and then decodes the LDDP information to determine the device and port to which the other end of the network cable is connected.

In some examples, a suitable layer two protocol other than LLDP may be used, and establishing the link and receiving the identifying information may be accomplished in substantially the same manner as discussed above with regard to LLDP or in some other manner, in accordance with the particular protocol being used and how that protocol works. In other examples, a suitable protocol that is not a layer two protocol may be used to obtain the identifying information, and establishing the link and receiving the identifying information may be accomplished in substantially the same manner as discussed above with regard to LLDP or in some other manner, in accordance with the particular protocol being used and how that protocol works.

### Illustrative System

FIG. 5 is a block diagram illustrating an example of a system (500) for cabling assistance. System 500 includes portable handheld computing device 510, centralized system 519, and data center 513. Data center 513 includes network cable 514 and remote device 518. Network cable 514 has an endpoint 582 that is coupled to remote device 518, and network cable 514 has another endpoint 581.

In some examples, data center 513 is a large local network, data center, or the like installed at a location that may include a large number of network devices, such as sixty or more network devices, including remote device 518, and in which each of the network devices in data center 513 may each have a large number of links for cables, such as 1,000 or more links for each device.

Portable handheld computing device 510 is configured such that, upon endpoint 581 of network cable 514 being connected to portable handheld computing device 510, portable handheld computing device 510 establishes a link over network cable 514 between portable handheld computing device 510 and remote device 518. After establishing the link, portable handheld computing device 510 receives, at first endpoint 581 of network cable 514, at least identifying information via a neighbor discovery protocol. The identifying information includes identification of remote device 518. In some examples, the identifying information further includes identification of the port by which endpoint 582 of network cable 514 is connected to remote device 518. In some examples, the identifying information further includes information regarding the physical interfacing of the remote device 518 to portable handheld computing device 510. After receiving the identifying information, portable handheld device 510 decodes the identifying information.

In some examples, portable handheld computing device 510 is further configured to display, on a screen of portable handheld computing device 510, an identification of remote device 518 to which endpoint 582 of network cable 514 is connected, based on the identifying information. In some examples, portable handheld computing device 510 is further configured to display, on a screen of portable handheld computing device 510, an identification of the port of the remote device 518 to which endpoint 582 of network cable 514 is connected.

Portable handheld computing device 510 is further configured to communicate with centralized system 519. Centralized system 519 includes one or more computing devices. In some examples, portable handheld computing device 510 is configured to communicate wirelessly with centralized system 519. In some examples, centralized system 519 includes a centralized topology service. In some examples, the centralized topology service includes a database that includes information on the intended topology of data center 513. In some examples, portable handheld computing device sends the identifying information to centralized system 519, and centralized system 519 uses the identifying information to analyze what is connected to endpoint 582 of network cable 514. In some examples, centralized system 519 cross-references the identifying information with information stored in one or more databases in centralized system 519.

In some examples, centralized system 519 returns information regarding the topology back to portable handheld computing device 510. In some examples, centralized system 519 returns topology information to portable handheld computing device 510, including information regarding where endpoint 581 of network cable 514 should be connected based on the topology information stored in centralized system 519. For example, the topology information sent from centralized system 519 to portable handheld computing device 510 may include identification of the device and/or port to which endpoint 581 of network cable 514 should be connected based on the topology stored in centralized system 519. In some examples, portable handheld computing device 510 is configured to synchronize with one or more databases in centralized system 519 that include information regarding the intended topology of data center 513.

Examples of portable handheld computing device 510 may be useful in an initial large network installation, for example, in ensuring that devices are cabled up correctly during the initial installation while building and/or installing the network. Examples of portable handheld device 510 may also be useful in maintaining a network after installation. For example, portable handheld device 510 may be used as a diagnostic tool to assist in troubleshooting the network, including by assisting in finding and fixing issues in the network reliably. Although FIG. 5 literally only shows one device and one cable in data center 513, some examples of data center 513 include many more devices and many more cables than shown.

Portable handheld computing device 510 is portable and can be moved around so to as to be interfaced with any of the cables in data center 513. Examples of portable handheld device 510 may be useful in the installation and maintenance of a network such as data center 513 in which, for example, there may be many devices in data center 513, such as sixty or more devices in data center 513, which each support over 1000 links, in which there is limited access to the devices, in tasks such as ensuring that links connect to the correct device on the correct port. While data center 513 is being installed, an operator may use an example of portable handheld computing device 510 to determine which port of which device any given cable should be connected to. Examples of portable handheld computing device 510 may also be used in other operations in which one cable is pulled from a large bundle of cables where the cable is to be connected to determine which device and which port the particular cable should be connected to.

In some examples, network cable 514 and some or all of the other cables in data center 513 are optical fiber cables. In other examples, network cable 514 and other cables in data center 513 may include suitable cables other than optical fiber cables, such as coaxial cables, twisted pair cables, power cables, and/or the like.

In some examples, after communicating with centralized service 519, portable handheld computing device 510 is configured to display, on a screen of portable handheld computing device 510, an identification of the device in data center 513 to which endpoint 581 of network cable 514 is to be connected according to the intended topology of data center 513. In some examples, portable handheld computing device 510 is further configured to display, on a screen of portable handheld computing device 510, an identification of the port of the device to which endpoint 581 of network cable 514 is to be connected according to the intended topology of data center 513.

In some examples, portable handheld computing device 510 uses LED beacons to direct the operator of portable handheld computing device 510 to the correct device and port in data 513 that endpoint 581 of network cable 514 should connect to, as discussed in greater detail below. In some examples, portable handheld computing device 510 has information regarding where the user is in the data center 513. In different examples, determining the location of the user may be accomplished in different ways.

For instance, in some examples, the location of portable handheld computing device 510 is accomplished through GPS. In other examples, the location of portable handheld computing device 510 is triangulated through radio beacons. In other examples, portable handheld device 510 may be used to scan the nearest serial number of the rack closest to the device to determine the current location of the device. In other examples, portable handheld device 510 can determine the location of portable handheld device 510 by detecting the signal strength of Wi-Fi transponders in range of portable handheld device 510. The signal strength of each Wi-Fi transponder will vary based on proximity of the Wi-Fi transponder to portable handheld device 510. Accordingly, in some examples, the signal strength received by portable handheld device 510 from the Wi-Fi transponders in range of portable handheld device 510 can be compared against known data to determine the location of portable handheld device 510. In other examples, the location of the user may be determined in other suitable ways.

In some examples, portable handheld computing device 510, in conjunction with centralized service 519, uses radio beacons to determine where the user is in data center 513. In some examples, each device in data center 513 contains several light-emitting diodes (LEDs), including one LED for each port and other LEDs for status, where the LEDs can be controlled to operate as beacons. In some examples, centralized system 519 can control the LEDs on the devices of data center 513, including separately controlling, for each LED, whether the LED is in an on state or on off state. In some examples, centralized system 519 controls LEDs in the devices of data center 513 responsive to communication with portable handheld computing device 510.

For instance, in some examples, devices in data center 513 have LEDs that operate as beacons. In some examples, portable handheld computing device 510 is capable of flashing LEDs on devices in data center 513 in such a way that the LEDs operate as beacons to help the user narrow down the device to which an endpoint of a cable should be connected. In some examples, portable handheld computing device 510 helps the user narrow down the device to which the endpoint of the cable should be connected by communicating with centralized system 519 to cause flashing of all of the red LEDs on devices to which the cable is not supposed to connect and flash on all the green LEDS on the device to which the cable is supposed to connect. Further, in some examples, the port to which the cable is supposed to connect blinks green at a faster rate than the rate at which the other green LEDs are blinking. This is one example of the LEDs functioning as beacons.

In some examples, a control unit in portable handheld computing device 510 is configured to, in response to a beacon activation request, control sending a beacon activation signal to centralized service 519 for an activation of beacons for locating the second network device. In some examples, the user may press a button on portable computing device 510, which in turn causes a beacon activation request to be sent to the control unit in portable handheld computing device 510. In some examples, upon centralized service 519 receiving the beacon activation signal from portable handheld computing device 510, centralized service 519 causes flashes in the LED beacons in data center 513 in the manner discussed above.

In this way, in some examples, as previous discussed, the operator may, for example, by pressing a particular button on portable handheld computing device 510, cause, via centralized service 519, LED beacons to flash in data center 513 to help the operator narrow down the device to which endpoint 581 of network cable 514 should be connected. As previously discussed, in some examples, upon the operator pressing the button, red LEDs blink on devices not supported, and green LEDs flash on devices that support connection, with the correct port flashing green at a faster rate than the other green flashing LEDs. In other examples, other suitable LED flashing patterns may be employed. In some examples, upon the user letting go of the button on their portable handheld computing device, this action signals centralized system 519 to disable the flashing of the LED beacons in data center 513. In some examples, centralized system 519 is also programmed with a max beacon timer to limit how long the LED beacons will flash per press of the button that activates the flashing of the LED beacons.

In some examples, portable handheld computing devices such as portable handheld computing device 510 are configured to accommodate multiple operators working in the same area, with each operator using a separate portable handheld computing device 510. In some such examples, central system 519 has information about how many requests from how many portable handheld computing devices are beaconing at the same time in the same area, and the portable handheld computing devices 510 can display, for example on a screen of portable handheld computing device 510, whether the beacons are for the operator or for the operator of another one of the portable handheld computing devices 510.

As previously discussed, in addition to using portable handheld computing device 510 to assist in the initial cable installation for data center 513, portable handheld computing device 510 may also be used to help with long-term maintenance of cables. For example, in cases where there are faults, an operator could walk around the data center 513 with portable handheld device 510 and query for problem links. For example, portable handheld device 510 may be used as a diagnostic tool to assist in troubleshooting the network in several different ways. In some examples, centralized system 519 will have previously identified these links and while the operator, holding portable handheld computing device 510, is in an aisle that has issues, centralized system 519 may use blinking behavior of devices in data center 513, such as the blinking behavior previously discussed or another suitable blinking behavior, to assist the operator in determining which cable should be pulled out.

In some examples, during troubleshoot of data center 513 with portable handheld computing device 510, portable handheld computing device 510 may provide information to the operator about what to do, and why, to fix the fault or other issue in data center 513. For instance, in some examples, portable handheld computing device 510 may inform the operator, via a suitable display on a screen of portable handheld computing device 510, what to do, which may include informing the operator to clean the cable, move the cable to a different port, or change out a transceiver (e.g., an optical transceiver). In some examples, centralized system 519 is also able to coordinate any traffic shifting or notifications and logging of working that is appropriate as a result by the issue or a result of fixing the issue.

### CONCLUSION

While the above Detailed Description describes certain examples of the technology, and describes the best mode contemplated, no matter how detailed the above appears in text, the technology can be practiced in many ways. Details may vary in implementation, while still being encompassed by the technology described herein. As noted above, particular terminology used when describing certain features or aspects of the technology should not be taken to imply that the terminology is being redefined herein to be restricted to any specific characteristics, features, or aspects with which that terminology is associated. In general, the terms used in the following claims should not be construed to limit the technology to the specific examples disclosed herein, unless the Detailed Description explicitly defines such terms. Accordingly, the actual scope of the technology encompasses not only the disclosed examples, but also all equivalent ways of practicing or implementing the technology.

We claim:

1. An apparatus for cabling assistance, comprising:
a portable handheld computing device, including:
a network interface that is configured to interface the portable handheld computing device to a network cable; and
a control unit that is configured to establish a link over the network cable; to receive, at a first endpoint of the network cable, at least identifying information via a neighbor discovery protocol, wherein the identifying information includes identification of a first network device to which a second endpoint of the network cable is connected; and to decode the identifying information.

2. The apparatus of claim 1, wherein the identifying information further includes identification of a port of the first network device to which the second endpoint of the network cable is connected.

3. The apparatus of claim 1, wherein the network cable is an optical fiber cable.

4. The apparatus of claim 1, wherein the neighbor discovery protocol is at least one of Link Layer Discovery Protocol, Link Layer Topology Discovery, Cisco Discovery Protocol, Foundry Discovery Protocol, Nortel Discovery Protocol, Simple Network Management Protocol, or SynOptics Network Management Protocol.

5. The apparatus of claim 1, wherein the control unit is further configured to control communication with a centralized service, wherein the communication with the centralized service includes sending, to the centralized service, at least a portion of the identifying information, and receiving, from the centralized service, topology information related to the first network device.

6. The apparatus of claim 5, wherein the topology information includes an identification of a second network device to which the first endpoint of the network cable should be connected in accordance with a topology stored by the centralized service.

7. The apparatus of claim 6, wherein the control unit is further configured to, in response to a beacon activation request, control sending a beacon activation signal to the centralized service for an activation of beacons for locating the second network device.

8. The apparatus of claim 6, where the topology information further includes identification of a port of the second network device to which the first endpoint of the network cable should be connected in accordance with the topology stored by the centralized service.

9. The apparatus of claim 8, wherein the portable handheld computing device further includes a screen, and where the control unit is further configured to control, responsive to receiving the topology information, displaying on the screen of the portable handheld computing device an identification of the second network device and the port of the second network device to which the first endpoint of the network cable should be connected in accordance with the topology stored by the centralized service.

10. A method for cabling assistance, comprising:
establishing a link over the network cable between a portable handheld computing device that is connected to a first endpoint of the network cable and a first network device that is connected to the second endpoint of the network cable; and
receiving, at the first endpoint of the network cable, at least identifying information via a neighbor discovery protocol, wherein the identifying information includes identification of the first network device; and
decoding the identifying information.

11. The method of claim 10, wherein the identifying information further includes identification of a port of the first network device to which the second endpoint of the network cable is connected.

12. The method of claim 10, wherein the neighbor discovery protocol is at least one of Link Layer Discovery Protocol, Link Layer Topology Discovery, Cisco Discovery Protocol, Foundry Discovery Protocol, Nortel Discovery Protocol, Simple Network Management Protocol, or SynOptics Network Management Protocol.

13. The method of claim 10, further comprising controlling communication with a centralized service, wherein controlling communication with the centralized service includes controlling sending, to the centralized service, at least a portion of the identifying information, and receiving, from the centralized service, topology information related to the first network device.

14. The method of claim 13, wherein the topology information includes an identification of a second network device to which the first endpoint of the network cable should be connected in accordance with a topology stored by the centralized service.

15. The method of claim 14, further comprising, in response to a beacon activation request, controlling sending a beacon activation signal to the centralized service for an activation of beacons for locating the second network device.

16. A processor-readable storage medium, having stored thereon process-executable code for cabling assistance, that, upon execution by at least one processor, enables actions, comprising:
establishing a link over the network cable between a portable handheld computing device that is connected to a first endpoint of the network cable and a first network device that is connected to the second endpoint of the network cable; and
receiving, at the first endpoint of the network cable, at least identifying information via a neighbor discovery protocol, wherein the identifying information includes identification of the first network device; and
decoding the identifying information.

17. The processor-readable medium of claim 16, wherein the identifying information further includes identification of a port of the first network device to which the second endpoint of the network cable is connected.

18. The processor-readable medium of claim 16, wherein the neighbor discovery protocol is at least one of Link Layer Discovery Protocol, Link Layer Topology Discovery, Cisco Discovery Protocol, Foundry Discovery Protocol, Nortel Discovery Protocol, Simple Network Management Protocol, or SynOptics Network Management Protocol.

19. The processor-readable medium of claim 16, the actions further comprising controlling communication with a centralized service, wherein controlling communication with the centralized service includes controlling sending, to the centralized service, at least a portion of the identifying information, and receiving, from the centralized service, topology information related to the first network device.

20. The processor-readable medium of claim 19, wherein the topology information includes an identification of a second network device to which the first endpoint of the network cable should be connected in accordance with a topology stored by the centralized service.
